(19) United States
(12) Patent Application Publication
(10) Pub. No.: US 2007/0196654 A1
(43) Pub. Date: Aug. 23, 2007

(54) Composite particle, composite material including the same, and method of producing the same

(75) Inventor: Akihide Furukawa, Ueda-shi (JP)

Correspondence Address: BIRCH STEWART KOLASCH & BIRCH, PO BOX 747, FALLS CHURCH, VA, 22040-0747, US

(73) Assignee: Shinano Kenshi Kabushiki Kaisha

(21) Appl. No.: 11/706,978

(22) Filed: Feb. 16, 2007

(30) Foreign Application Priority Data
Feb. 20, 2006 (JP) 2006-43138

(51) Int. Cl. B32B 5/16; C08K 9/00

(52) U.S. Cl. 428/402; 977/742; 428/403; 523/200

(57) ABSTRACT

The composite particle is capable of being firmly adhered to resin, etc. The composite particle of the present invention comprises: a nickel particle, in which a large number of stabber-shaped projections are provided in an outer surface; and a large number of microfine fibers being incorporated in the nickel particle. The nickel particles are deposited in an alkaline solution by a wet reduction process.

### BACKGROUND OF THE INVENTION

The present invention relates to a composite particle, a composite material including the composite particles, and a method of producing the composite particle.

Spherical nickel particles having diameters of several μm are used as electrically conductive fillers. They are produced by, for example, a carbonyl process or an atomize process.

Nickel particles can be produced by the carbonyl process, an atomize process, a CVD process, a wet reduction process, etc. These days, in the wet reduction process, an alkaline solution of nickel salt is warmed with adding hydrazine hydrate thereto so as to perform reduction, so that nickel particles, which are formed into spherical shapes and have diameters of submicrometer to several μm, can be reduced (see Japanese Patent Gazette No. 9-291318).

In the generally used carbonyl process, atomize process and wet reduction process, nickel particles are formed into spherical shapes and have smooth surfaces. Therefore, the nickel particles cannot be firmly adhered to resin. The adjacent nickel particles mutually contact at only one point, so improving electrical conductivity is limited.

### SUMMARY OF THE INVENTION

The present invention was conceived to solve the above described problems.

An object of the present invention is to provide a composite particle capable of being firmly adhered to resin, etc.

Another object is to provide a composite material including said composite particles. Further object is to provide a method of producing said composite particle.

To achieve the objects, the present invention has following structures. Namely, the composite particle of the present invention comprises: a nickel particle, in which a large number of stabber-shaped projections are provided in an outer surface; and a large number of microfine fibers being incorporated in the nickel particle.

In the composite particle, parts of the microfine fibers may be projected from the nickel particle.

In the composite particle, a particle diameter of the nickel particle may be 0.1-10 μm.

In the composite particle, the microfine fibers may be electrically conductive microfine fibers, e.g., carbon nanotubes, metal fibers.

In the composite particle, the outer surface of the nickel particle may be coated with a metal film.

The composite material of the present invention comprises: a matrix resin; and the composite particles of the present invention being mixed with the matrix resin.

The method of producing composite particles of the present invention comprises the steps of:

adding a nickel compound, which acts as a nickel source, to a solution, in which microfine fibers, such as carbon nanotubes, are dispersed;

producing an alkaline solution by adding alkali to the solution; and

reducing nickel by warming the alkaline solution and adding a reducing agent constituted by hydrazine or hydrazine hydrate thereto, and

the method is characterized in that nickel particles, in each of which a large number of stabber-shaped projections are provided in an outer surface and the microfine fibers are incorporated, are deposited in the alkaline solution by a wet reduction process.

Another method of producing composite particles comprises the steps of:

adding a nickel compound, which acts as a nickel source, to a solution, in which microfine fibers, such as carbon nanotubes, are dispersed;

producing an alkaline solution by adding alkali to the solution; and

reducing nickel by warming the alkaline solution and adding a reducing agent constituted by hydrazine or hydrazine hydrate thereto, and

the method is characterized in that nickel particles, in each of which a large number of stabber-shaped projections are provided in an outer surface and the microfine fibers are incorporated, are deposited by adding at least one substance selected from a group consisting of a sulfate ion source, an ammonia or ammonium ion source, and a nitrate ion source to the alkaline solution.

In each of the methods, metal powder or ceramic powder may be added to the alkaline solution.

In each of the methods, a carbonate ion source may be added to the alkaline solution.

In each of the methods, the microfine fibers may be electrically conductive microfine fibers, e.g., carbon nanotubes, metal fibers.

In each of the methods, the microfine fibers may be dispersed with gelatin.

### By employing the present invention, the composite particle, in which a large number of the stabber-shaped projections are formed in the outer surface and a large number of the microfine fibers are incorporated, can be provided.

The composite particle, in which a large number of the stabber-shaped projections are formed in the outer surface, a large number of the microfine fibers are incorporated and parts of the microfine fibers are projected from the outer surface, can be provided.

By mixing the composite particles with the matrix resin to produce the composite material, each of the stabber-shaped projections and the microfine fibers mutually contact at a plurality of points, so that electrical conductivity of the composite material can be improved.

### BRIEF DESCRIPTION OF THE DRAWINGS

Embodiments of the present invention will now be described by way of examples and with reference to the accompanying drawings, in which:

FIG. 1 is an SEM photograph of composite particles produced as Example 1;

FIG. 2 is an enlarged photograph of the composite particles of FIG. 1;

FIG. 3 is a further enlarged photograph of the composite particles of FIG. 1;

FIG. 3 is a further enlarged photograph of the composite particles of FIG. 1;

FIG. 4 is an SEM photograph of composite particles produced as Example 2;

FIG. 5 is an enlarged photograph of the composite particles of FIG. 4;

FIG. 6 is an SEM photograph of composite particles produced as Example 3;

FIG. 7 is an SEM photograph of composite particles produced as Example 4; and

FIG. 8 is an SEM photograph of composite particles produced as Example 5.

### DETAILED DESCRIPTION OF THE EMBODIMENTS

Preferred embodiments of the present invention will now be described in detail with reference to the accompanying drawings.

As described above, the method of producing the composite particle of the present invention comprises the steps of: adding a nickel compound, which acts as a nickel source, to a solution, in which microfine fibers, such as carbon nanotubes, are dispersed; producing an alkaline solution by adding alkali to the solution; and reducing nickel by warming the alkaline solution and adding a reducing agent constituted by hydrazine or hydrazine hydrate thereto, and the method is characterized in that nickel particles, in each of which a large number of stabber-shaped projections are provided in an outer surface and the microfine fibers are incorporated, are deposited by adding at least one substance selected from a group consisting of a sulfate ion source, an ammonia or ammonium ion source, and a nitrate ion source to the alkaline solution.

Nickel salts, e.g., nickel chloride, nickel sulfate, and other nickel compounds having a following chemical formula CM1, e.g., basic nickel carbonate, may be used as the nickel source.

CM1: xNiCO3·yNi(OH)2·zH2O

The nickel compound may be used solely or together with another nickel compound(s).

The pH value of the solution is adjusted by alkali. Preferably, NaOH is used as alkali, but it is not limited. In a reduction process of nickel with hydrazine, concentration of alkali, which acts as a hydroxide ion source, must be higher than a prescribed concentration, and a proper pH value of the alkaline solution is 10 or more. Particle diameters of nickel particles can be controlled by the pH value of the solution. Therefore, the pH value is controlled on the basis of an object particle diameter of the nickel particles.

Microfine fibers whose diameter is 1 μm or less and whose aspect ratio (length/diameter) is 2 or more can be used. For example, electrically conductive microfine fibers (e.g., carbon nanotubes, microfine metal fibers), microfine silica fibers, microfine resin fibers, etc. may be used as the microfine fibers.

The microfine fibers may be dispersed by performing acid treatment with at least one acid selected from a group consisting of nitric acid, sulfuric acid and hydrochloric acid, and applying ultrasonic vibration to the solution or mechanically agitating the solution with adding a dispersing agent thereto. For example, octylphenoxy polyethoxyethanol, dodecyl sodium sulfate, polyacrylic acid or gelatin may be used as the dispersing agent.

To well disperse the microfine fibers in the solution, ultrasonic vibration may be applied to the solution, to which the dispersing agent has been added.

Since alkali is consumed by the reductive reaction of hydrazine, hydroxide ions in the solution are reduced. If hydroxide ions in the solution are dramatically reduced, the proper pH value of the solution cannot be maintained.

Thus, alkali may be added to the solution during the reaction.

A proper amount of hydrazine hydrate is defined as contained hydrazine is 1-20 mol with respect to 1 mol of nickel in the solution. Preferably, reaction temperature is maintained at 50-70° C. so as to efficiently react the hydrazine hydrate.

By adding at least one kind of ions selected from sulfate ions, ammonia or ammonium ions and nitrate ions to the reduction solution and adding hydrazine or hydrazine hydrate so as to reduce nickel, the nickel particles, each of which has a large number of stabber-shaped projections in an outer surface and in each of which the microfine fibers, e.g., carbon nanotubes, are incorporated, can be produced.

Preferably, a minute amount of metal powder (e.g., nickel powder, palladium powder), metal ions, metal oxide, ceramic powder, organic powder and/or inorganic powder may be previously added to the reduction solution. We think that the metal powder, etc. accelerate the reductive reaction, in which nickel ions in the reduction solution is reduced and deposited as nickel particles, as a catalytic agent, cores or seeds.

Sulfate salts, e.g., sodium sulfate, potassium sulfate, may be used as the sulfate ion source besides sulfuric acid. In the presence of sulfate ions, the reductive reaction relatively stably proceeds. An amount of the sulfate ion source is defined as concentrated sulfuric acid is 10 mol or less, preferably 6 mol or less, with respect to 1 mol of nickel. If the amount of concentrated sulfuric acid is more than 10 mol with respect to 1 mol of nickel, a large amount of alkali must be undesirably required.

Ammonia water and ammonium salts, e.g., ammonium chloride, may be used as the ammonia or ammonium ion source. An amount of the ammonia or ammonium ion source is defined as concentrated ammonia water is 20 mol or less, preferably 10 mol or less, with respect to 1 mol of nickel. If the amount of concentrated ammonia water is more than 20 mol with respect to 1 mol of nickel, deposited nickel particles will adhere each other or will form into a plate-shape. Namely, the desired nickel particles cannot be gained.

Nitrate salts, e.g., sodium nitrate, potassium nitrate, may be used as the nitrate ion source besides nitric acid. In the presence of nitrate ions, the reductive reaction takes a long time, but it is improper to add a large amount of nitrate ions, which exceed a prescribed amount. Therefore, the amount of the nitrate ion source is defined as concentrated nitric acid is 10 mol or less, preferably 6 mol or less, with respect to 1 mol of nickel. If the amount of concentrated sulfuric acid is more than 10 mol with respect to 1 mol of nickel, a large amount of alkali must be undesirably required.

By adding sulfate ions, or ammonia or ammonium ions in the reduction solution, nickel particles become fine particles, which have uniform diameters of submicrometer. On the other hand, in the presence of nitrate ions, nickel particles become coarse particles, which are relatively large and have diameters of several μm. Further, their particle diameters are dispersed.

Therefore, nickel particles having an object diameter can be produced by controlling the amounts of sulfate ions, ammonia or ammonium ions and nitrate ions, i.e., the ion sources.

By controlling the amounts of sulfate ions, ammonia or ammonium ions and nitrate ions and the pH value, nickel particles, whose a center part range of normal distribution of diameters is 0.1-10 μm, can be produced.

Sizes of stabber-shaped projections are small, and their heights are lower than a quarter (¼) of the particle diameter. The projections are formed like quadrangular pyramids, circular cones, etc. A large number of the stabber-shaped projections are thickly and integrally formed on an outer surface of each spherical nickel particle. Since the stabber-shaped projections are micro fine projections, a surface area of each nickel particle is highly broadened.

Further, additive agents for stabilizing and accelerating the reductive reaction may be added.

Carbonate compounds, e.g., sodium carbonate, are the suitable additive agents. When a large amount of ammonium ions, which contribute to form the stabber-shaped projections, exist, the ammonium ions perform pH-buffering action with carbonate ions. Note that, carbonate ions restrain diameter dispersion of the nickel particles and work to uniformly form the stabber-shaped projections, we think.

Acetic acid compounds, glycine, citric acid compounds, sodium succinate, malic acid, etc. may be used as additive agents.

The composite particles produced by the above described method are mixed with matrix resin so as to produce a composite material, e.g., electrically conductive resin. The matrix resin is not limited. Since the composite particles of the above described embodiment includes the nickel particles, in each of which the stabber-shaped projections are formed in the outer surface thereof, each of the stabber-shaped projections can contact the adjacent stabber-shaped projections at a plurality of points. Therefore, electrical conductivity of the composite material can be improved. By the stabber-shaped projections, the matrix resin can firmly adheres to the composite particles so that strength of the composite material can be improved.

The composite material may be used as an electrically conductive material, e.g., electrically conductive paste, a material of electric contact points, a material of battery electrodes, an electron emission material, etc.

To further improve electrical conductivity, surfaces of the nickel particles may be coated with a noble metal, e.g., silver, gold, platinum, by sputtering, a CVD process, etc.

Successively, experimental examples will be explained.

### EXAMPLE 1

Ion-exchange water: 80 ml

Nickel chloride hexahydrate: 8 g

Sodium carbonate: 14 g

Concentrated sulfuric acid: 0.25 ml

Concentrated nitric acid: 0.25 ml

Sodium hydroxide solution

Concentrated ammonia water: 0.25 ml

Hydrazine hydrate: 6 ml

Carbon nanotubes

Gelatin

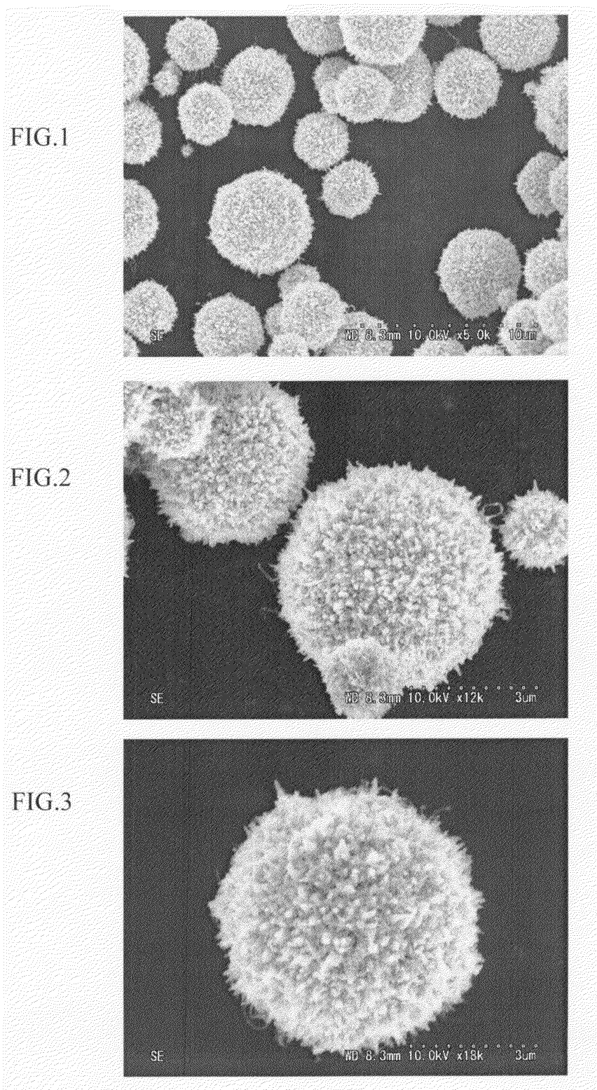

A base solution was produced by mixing carbon nanotubes and gelatin with 80 ml of ion-exchange water and dispersing them with an ultrasonic homogenizer. Next, 0.25 ml of concentrated sulfuric acid, 0.25 ml of concentrated nitric acid and 4.17 mol/l of sodium hydroxide solution were added to the base solution so as to produce an alkaline solution. Further, 8 g of nickel chloride hexahydrate, 14 g of sodium carbonate and 4.17 mol/l of sodium hydroxide solution were added so as to adjust a pH value of the alkaline solution to about pH 12 with pH test paper (trade name: DUOTEST pH9.5-14). 0.25 ml of concentrated ammonia water was further added. The alkaline solution was stored in an oil bath and maintained at temperature about 60° C., and 6 ml of hydrazine hydrate was added for the reductive reaction. The reductive reaction was terminated within six hours, and composite particles, in each of which a large number of stabber-shaped nickel projections were formed in an outer surface, the carbon nanotubes were incorporated and ends of the carbon nanotubes were projected from the outer surface, were produced. SEM photographs of the produced composite particles, whose scale factors were different, are shown in FIGS. 1-3.

### EXAMPLE 2

Ion-exchange water: 80 ml

Nickel chloride hexahydrate: 8 g

Sodium carbonate: 14 g

Concentrated sulfuric acid: 0.25 ml

Concentrated nitric acid: 0.25 ml

Sodium hydroxide solution

Concentrated ammonia water: 0.25 ml

Hydrazine hydrate: 6 ml

Carbon nanotubes

Firstly, carbon nanotubes were acid-treated with concentrated sulfuric acid and concentrated nitric acid (volume ratio 50:50), and the carbon nanotubes were filtered and cleaned.

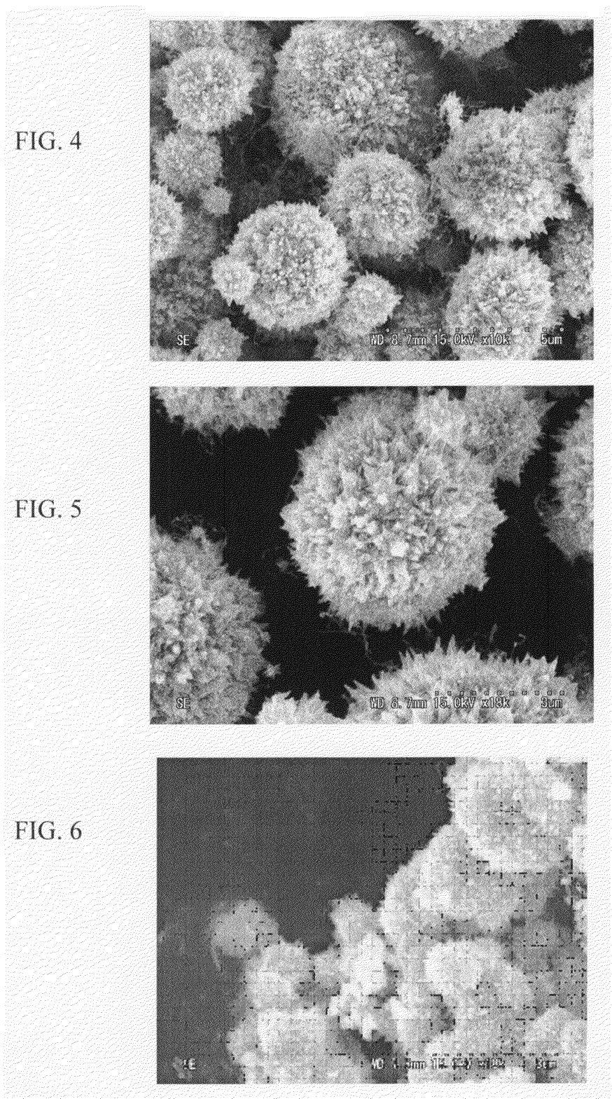

A base solution was produced by dispersing the carbon nanotubes in 80 ml of ion-exchange water with an ultrasonic homogenizer. Next, 0.25 ml of concentrated sulfuric acid, 0.25 ml of concentrated nitric acid and 4.17 mol/l of sodium hydroxide solution were added to the base solution so as to produce an alkaline solution. Further, 8 g of nickel chloride hexahydrate, 14 g of sodium carbonate and 4.17 mol/l of sodium hydroxide solution were added so as to adjust a pH value of the alkaline solution to about pH 12 with pH test paper (trade name: DUOTEST pH9.5-14). 0.25 ml of concentrated ammonia water was further added. The alkaline solution was stored in an oil bath and maintained at temperature about 60° C., and 6 ml of hydrazine hydrate was added for the reductive reaction. The reductive reaction was terminated within six hours, and composite particles, in each of which a large number of stabber-shaped nickel projections were formed in an outer surface, the carbon nanotubes were incorporated and ends of the carbon nanotubes were projected from the outer surface, were produced. SEM photographs of the produced composite particles, whose scale factors were different, are shown in FIGS. 4 and 5.

### EXAMPLE 3

Ion-exchange water: 80 ml

Nickel chloride hexahydrate: 8 g

Concentrated sulfuric acid: 0.2 ml

Sodium hydroxide solution

Hydrazine hydrate: 6 ml

Carbon nanotubes

Gelatin

A base solution was produced by mixing carbon nanotubes and gelatin with 80 ml of ion-exchange water and dispersing them with an ultrasonic homogenizer. Next, 0.2 ml of concentrated sulfuric acid and 4.17 mol/l of sodium hydroxide solution were added to the base solution so as to produce an alkaline solution. Further, 8 g of nickel chloride hexahydrate, 14 g of sodium carbonate and 4.17 mol/l of sodium hydroxide solution were added so as to adjust a pH value of the alkaline solution to about pH 12 with pH test paper (trade name: DUOTEST pH9.5-14). The alkaline solution was stored in an oil bath and maintained at temperature about 60° C., and 6 ml of hydrazine hydrate was added for the reductive reaction. The reductive reaction was terminated within six hours, and composite particles, in each of which a large number of stabber-shaped nickel projections were formed in an outer surface, the carbon nanotubes were incorporated and ends of the carbon nanotubes were projected from the outer surface, were produced. An SEM photograph of the produced composite particles is shown in FIG. 6.

### EXAMPLE 4

Ion-exchange water: 80 ml

Nickel chloride hexahydrate: 8 g

Concentrated ammonia water: 0.1 ml

Sodium hydroxide solution

Hydrazine hydrate: 6 ml

Carbon nanotubes

Gelatin

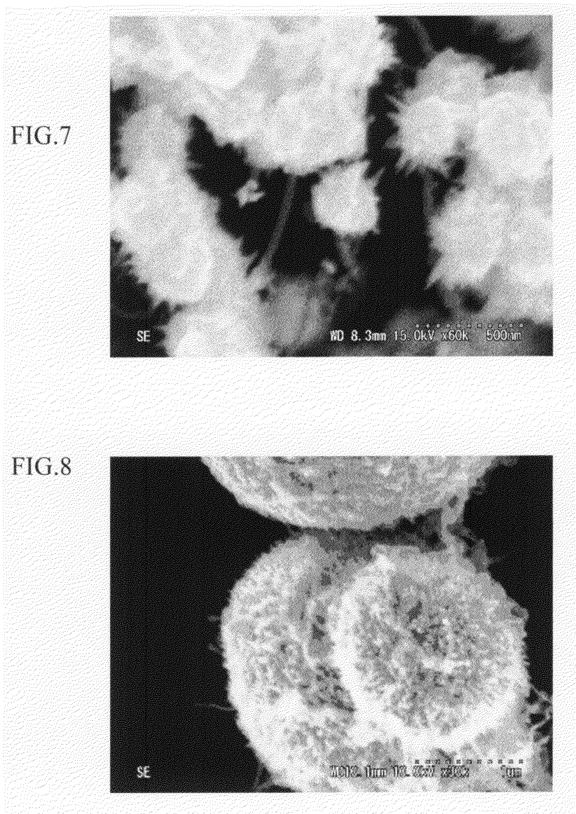

A base solution was produced by mixing carbon nanotubes and gelatin with 80 ml of ion-exchange water and dispersing them with an ultrasonic homogenizer. Next, 4.17 mol/l of sodium hydroxide solution were added to the base solution so as to produce an alkaline solution. Further, 8 g of nickel chloride hexahydrate and 4.17 mol/l of sodium hydroxide solution were added so as to adjust a pH value of the alkaline solution to about pH 12 with pH test paper (trade name: DUOTEST pH9.5-14). The alkaline solution was stored in an oil bath and maintained at temperature about 60° C., and 6 ml of hydrazine hydrate was added for the reductive reaction. The reductive reaction was terminated within six hours, and composite particles, in each of which a large number of stabber-shaped nickel projections were formed in an outer surface, the carbon nanotubes were incorporated and ends of the carbon nanotubes were projected from the outer surface, were produced. An SEM photograph of the produced composite particles is shown in FIG. 7.

### EXAMPLE 5

Ion-exchange water: 80 ml

Nickel chloride hexahydrate: 8 g

Concentrated nitric acid: 0.25 ml

Sodium carbonate: 14 g

Sodium hydroxide solution

Concentrated ammonia water: 0.25 ml

Hydrazine hydrate: 6 ml

Carbon nanotubes

Gelatin

A base solution was produced by mixing carbon nanotubes and gelatin with 80 ml of ion-exchange water and dispersing them with an ultrasonic homogenizer. Next, 0.25 ml of concentrated nitric acid and 4.17 mol/l of sodium hydroxide solution were added to the base solution so as to produce an alkaline solution. Further, 8 g of nickel chloride hexahydrate, 14 g of sodium carbonate and 4.17 mol/l of sodium hydroxide solution were added so as to adjust a pH value of the alkaline solution to about pH 12 with pH test paper (trade name: DUOTEST pH9.5-14). 0.25 ml of concentrated ammonia water was further added. The alkaline solution was stored in an oil bath and maintained at temperature about 60° C., and 6 ml of hydrazine hydrate was added for the reductive reaction. The reductive reaction was terminated within 15 hours, and composite particles, in each of which a large number of stabber-shaped nickel projections were formed in an outer surface, the carbon nanotubes were incorporated and ends of the carbon nanotubes were projected from the outer surface, were produced. An SEM photograph of the produced composite particles is shown in FIG. 8.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A composite particle,
comprising:
a nickel particle, in which a large number of stabber-shaped projections are provided in an outer surface; and
a large number of microfine fibers being incorporated in said nickel particle.

2. The composite particle according to claim 1,
wherein parts of said microfine fibers are projected from said nickel particle.

3. The composite particle according to claim 1,
wherein a particle diameter of said nickel particle is 0.1-10 μm.

4. The composite particle according to claim 1,
wherein said microfine fibers are carbon nanotubes.

5. The composite particle according to claim 1,
wherein the outer surface of said nickel particle is coated with a metal film.

6. A composite material,
comprising:
a matrix resin; and
composite particles being mixed with said matrix resin,
wherein each of said composite particles comprises:
a nickel particle, in which a large number of stabber-shaped projections are provided in an outer surface; and a large number of microfine fibers being incorporated in said nickel particle.

7. The composite material according to claim 6,
wherein parts of said microfine fibers are projected from each of said nickel particles.

8. A method of producing composite particles,
comprising the steps of:
adding a nickel compound, which acts as a nickel source, to a solution, in which microfine fibers, such as carbon nanotubes, are dispersed;
producing an alkaline solution by adding alkali to the solution; and
reducing nickel by warming the alkaline solution and adding a reducing agent constituted by hydrazine or hydrazine hydrate thereto,
wherein nickel particles, in each of which a large number of stabber-shaped projections are provided in an outer surface and the microfine fibers are incorporated, are deposited in the alkaline solution by a wet reduction process.

9. The method according to claim 8,
wherein metal powder or ceramic powder is added to the alkaline solution.

10. The method according to claim 8,
wherein a carbonate ion source is added to the alkaline solution.

11. The method according to claim 8,
wherein the microfine fibers are carbon nanotubes.

12. The method according to claim 11,
wherein the carbon nanotubes are dispersed with gelatin.

13. A method of producing composite particles,
comprising the steps of:
adding a nickel compound, which acts as a nickel source, to a solution, in which microfine fibers, such as carbon nanotubes, are dispersed;
producing an alkaline solution by adding alkali to the solution; and
reducing nickel by warming the alkaline solution and adding a reducing agent constituted by hydrazine or hydrazine hydrate thereto,
wherein nickel particles, in each of which a large number of stabber-shaped projections are provided in an outer surface and the microfine fibers are incorporated, are deposited by adding at least one substance selected from a group consisting of a sulfate ion source, an ammonia or ammonium ion source, and a nitrate ion source to the alkaline solution.

14. The method according to claim 13,
wherein metal powder or ceramic powder is added to the alkaline solution.

15. The method according to claim 13,
wherein a carbonate ion source is added to the alkaline solution.

16. The method according to claim 13,
wherein the microfine fibers are carbon nanotubes.

17. The method according to claim 16,
wherein the carbon nanotubes are dispersed with gelatin.
